(19) United States
(12) Patent Application Publication
(10) Pub. No.: US 2011/0159259 A1
(43) Pub. Date: Jun. 30, 2011

(54) Molded Article for Electronic Device Housing and Method for Preparing the Same

(75) Inventors: Jee Kwon Park, Uiwang-si (KR); Jin Hwan Choi, Uiwang-si (KR); Kang Yeol Park, Uiwang-si (KR); Jun Myung Kim, Uiwang-si (KR); Jae Won Lee, Uiwang-si (KR); Yoon Sook Lim, Uiwang-si (KR)

(73) Assignee: CHEIL INDUSTRIES INC., Gumi-si (KR)

(21) Appl. No.: 12/980,685

(22) Filed: Dec. 29, 2010

(30) Foreign Application Priority Data
Dec. 31, 2009 (KR) 10-2009-0135046
Oct. 19, 2010 (KR) 10-2010-0101870

(51) Int. Cl. B32B 7/02; B32B 27/00; B32B 27/30; B32B 27/32; B32B 27/36; B29C 51/36

(52) U.S. Cl. 428/213; 428/220; 264/571

(57) ABSTRACT

A molded article for an electronic device housing having a thickness of about 0.2 to about 2 mm and an apparent specific gravity of about 0.8 to about 2.5 g/ml is provided. A method for preparing the molded article for an electronic device housing includes extrusion molding a thermoplastic resin composition to form a continuous profile extrudate with a prescribed cross-sectional shape; and vacuum forming the continuous profile extrudate to form a molded article with a thickness of about 0.2 to about 2 mm and an apparent specific gravity of about 0.8 to about 2.5 g/ml.

### CROSS-REFERENCE TO RELATED APPLICATIONS

This application claims priority from Korea Patent Application Nos. 10-2009-0135046 and 10-2010-0101870, filed Dec. 31, 2009 and Oct. 19, 2010, respectively, in the Korean Intellectual Property Office, the disclosure of each of which is incorporated herein by reference in its entirety.

### FIELD OF THE INVENTION

The present invention relates to a molded article for an electronic device housing and a method for preparing the same.

### BACKGROUND OF THE INVENTION

Wood has long been used as a material for exterior housings of electronic products such as TVs, but was largely replaced by plastic resins in the 1960s. Recently, with the advent of LCD TVs, LED TVs, and the like, there is an increased need for TVs that are larger overall (with regard to width and height) but also have a reduced thickness (i.e., have a thinner profile) than conventional TVs.

When exterior components of large electronic products with reduced thickness (i.e., electronic products with a large height and width yet a thickness of 2 mm or less) are prepared by injection molding processes using general thermoplastic resins, it can be difficult and even impossible to mold the component with these dimensions due to resin-specific flowability characteristics. In addition, the appearance of the molded products can be poor due to weld lines and flow marks. This in turn can limit the usefulness of conventional plastic resins to produce large, yet thin, exterior components.

In order to overcome the above problems, iron plates may be used as exterior materials for TVs. This, however, undesirably increases the overall weight of the TV. Further, the use of iron plates can increase manufacturing costs due to coating processes required for colorability. Still further, the iron plates have limited design flexibility due to the stiffness of the iron plates.

### SUMMARY OF THE INVENTION

The present invention provides to a molded article for an electronic device housing that can have reduced thickness, for example, a thickness of about 2 mm or less. The molded article can also have a low specific gravity, a good exterior appearance, and reduced manufacturing costs. In exemplary embodiments, the molded article for an electronic device housing according to the present invention can have a thickness of about 0.2 to about 2 mm and an apparent specific gravity of about 0.8 to about 2.5 g/ml.

In exemplary embodiments of the present invention, the molded article for an electronic device housing can have a surface area/thickness ratio of about 300,000 to about 1,500,000 mm, for example about 500,000 to 1,500,000 mm, and can be in the form of a sheet material (or plate). In exemplary embodiments of the present invention, the molded article for an electronic device housing may be prepared by vacuum forming a flat sheet material (or flat board). The flat sheet material can be formed by extrusion molding and can be a monolayer or multilayer sheet material.

In exemplary embodiments of the present invention, the molded article for an electronic device housing can have a flexural modulus of about 1.8 to about 20 GPa.

In exemplary embodiments of the present invention, the molded article for an electronic device housing may be prepared from a thermoplastic resin which can be extrusion molded.

A method for preparing the molded article for an electronic device housing according to the present invention can comprise the steps of extrusion molding a thermoplastic resin composition to prepare a continuous profile extrudate with a prescribed cross-sectional shape; and vacuum forming the continuous profile extrudate to prepare a molded article with a thickness of about 0.2 to about 2 mm and an apparent specific gravity of about 0.8 to about 2.5 g/ml.

In exemplary embodiments of the present invention, the step of extrusion molding can comprise co-extrusion molding to prepare a multilayer continuous profile extrudate.

In exemplary embodiments of the present invention, in the step of extrusion molding, the continuous profile extrudate may be prepared in the form of a sheet material.

In exemplary embodiments of the present invention, ribs may be formed on the continuous profile extrudate using a mold having a desired shape to form the ribs during extrusion molding. The continuous profile extrudate may also be embossed using an embossing roll(s) with a desired surface pattern.

In exemplary embodiments of the present invention, the step of vacuum forming can comprise softening the continuous profile extrudate by heating, positioning the softened continuous profile extrudate on a vacuum forming mold with a plurality of holes, and reducing the internal pressure of the vacuum forming mold by rapidly discharging air present in the vacuum forming mold through the holes.

In exemplary embodiments of the present invention, the method for preparing the molded article for an electronic device housing may further comprise a step of forming holes in the molded article by a punching process after the step of vacuum forming.

### BRIEF DESCRIPTION OF THE DRAWINGS

FIG. 1 is a schematic diagram of an extrusion molding line.

FIG. 2 is a schematic diagram of a vacuum forming line.

FIG. 3 is a picture of a back cover for a 55″ TV prepared according to an exemplary embodiment of the present invention.

### DETAILED DESCRIPTION OF THE INVENTION

The present invention will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

Hereinafter, the present invention will be described in more detail.

A molded article for an electronic device housing according to the present invention can have a thickness of about 0.2 to about 2 mm and an apparent specific gravity of about 0.8 to about 2.5 g/ml.

When a product, such as an electronic device, includes an interior and/or exterior housing, the housing should have an attractive appearance, sufficient impact strength to protect the product, and sufficient flexural strength to maintain the shape of the product. The molded article for an electronic device housing according to the present invention can have these properties, as well as an advantage of reduced weight due to low specific gravity.

Generally, an electronic device housing with a thickness of about 2 mm or less should have a flexural modulus of about 1.8 GPa or more, for example a flexural modulus of about 1.8 to about 20 GPa, in order to achieve the properties required for an electronic device housing. The molded article for an electronic device housing according to the present invention can satisfy this range of flexural modulus.

The molded article for an electronic device housing according to the present invention can have a film shape with a thin thickness and a very large surface area.

In exemplary embodiments of the present invention, the molded article for an electronic device housing can have a surface area/thickness ratio of about 300,000 to about 1,500,000 mm, for example, about 500,000 to about 1,500,000 mm. When the molded article has a surface area/thickness ratio within this range, the molded article can be used as an electronic device housing.

The molded article for an electronic device housing can be in the form of a sheet material (also referred to herein as a plate). The sheet material (or plate) may have a smooth (or flat) surface. The present invention, however, is not limited to a sheet material solely having a smooth surface and also includes sheet materials with non-uniform surfaces, such as sheet materials including projections and/or other deviations from a flat surface thereof, such as concave portions and/or convex portions. For example, the molded article of the invention can include concave portions and/or convex portions in an assembly part or grill part. Accordingly, as used herein, reference to a sheet material includes both sheet materials with smooth surfaces and sheet materials with non-uniform surfaces.

In exemplary embodiments of the present invention, the molded article for an electronic device housing may be prepared by vacuum forming a flat sheet material (or flat board). The flat sheet material can be formed by extrusion molding and can be a monolayer or multilayer sheet material.

In exemplary embodiments of the present invention, the molded article for an electronic device housing can have a flexural modulus of about 1.8 to about 20 GPa.

Examples of the resin that can be used in an extrusion molding process according to the present invention may include without limitation thermoplastic resins, and the like, and combinations thereof.

Examples of the thermoplastic resin may include without limitation polyolefins, styrenic resins, polyesters, polycarbonates (PC), polymethyl methacrylates (PMMA), polyphenylene ethers (PPE), polyvinyl chloride (PVC), and the like. The thermoplastic resin may be used alone, or in combination with one another.

Examples of the polyolefin may include without limitation polyethylene such as low density polyethylene (LDPE), high density polyethylene (HDPE), ultra-high density polyethylene (UHDPE), and the like; polypropylene; polybutylene; polymethylpentane; copolymers thereof; and the like; and combinations thereof.

Examples of the polyester may include without limitation polyethylene terephthalate (PET), polybutylene terephthalate (PBT), polyethylene terephthalate glycol (PETG), copolymers thereof, and the like, and combinations thereof.

Examples of the styenic resins may include without limitation acrylonitrile-butadiene-styrene (ABS) copolymers, high impact polystyrenes (HIPS), acrylonitrile-styrene copolymer (SAN), acrylonitrile-styrene-acrylate copolymer (ASA), polystyrene (PS), and the like, and combinations thereof,

In exemplary embodiments of the present invention, the thermoplastic resin may include without limitation acrylonitrile-butadiene-styrene copolymer (ABS), acrylonitrile-styrene copolymer (SAN), acrylonitrile-styrene-acrylate copolymer (ASA), polycarbonate (PC), polyethylene terephthalate (PET), polymethyl methacrylate (PMMA), polyphenylene ether (PPE), polyvinyl chloride (PVC), polystyrene (PS), high density polyethylene (HDPE) or a combination thereof.

In one exemplary embodiment of the present invention, the thermoplastic resin may further comprise one or more additives such as but not limited to inorganic fillers, inorganic fibers, flame retardants, heat stabilizers, mold release agents, dispersants, anti-dripping agents, weather stabilizers, antistatic agents, antibacterial agents, and the like, and combinations thereof. The additive(s) can be used in conventional amounts, so long as the additive(s) does not affect the desired properties of the product.

The molded article according to the present invention may be used as electronic device housings for products including without limitation flat panel TVs such as LED TVs, LCD TVs and PDP TVs, monitors, notebook computers, entertainment devices, and the like.

A method for preparing the molded article for an electronic device housing according to the present invention can comprise the steps of extrusion molding a thermoplastic resin composition to prepare a continuous profile extrudate with a prescribed (predetermined or preselected) cross-sectional shape; and vacuum forming the continuous profile extrudate to prepare a molded article with a thickness of about 0.2 to about 2 mm and an apparent specific gravity of about 0.8 to about 2.5 g/ml.

In the step of extrusion molding, raw materials are supplied to an extruder and are extruded from a mold to prepare the continuous profile extrudate with the prescribed cross-sectional shape. Any of a variety of known extrusion molding methods can be used. Examples of the extruders used in the extrusion molding may include without limitation one-axial extruders, two-axial extruders, three-axial extruders, and the like.

In exemplary embodiments of the present invention, the two-axial extruder may be used as the extruder, taking into account productivity and mixing ability of the raw materials.

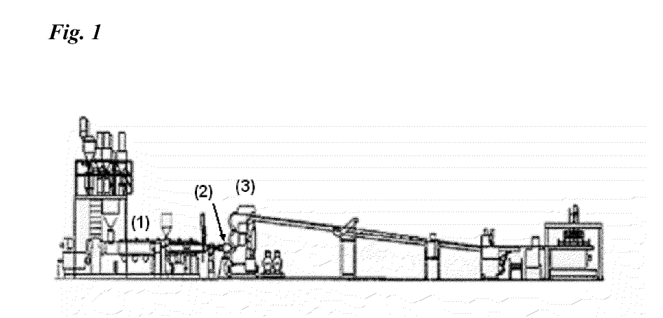

FIG. 1 illustrates a schematic diagram of an extrusion molding line that can be used in the method of the invention. The extrusion molding line can include an extruder (1), a mold (2), and roll (3), among other components. The shape of the continuous profile extrudate prepared by the step of extrusion molding may be in the form of flat sheet (or board), for downstream vacuum forming and optionally punching.

In exemplary embodiments of the present invention, ribs may be formed on the continuous profile extrudate by using a mold having a shape allowing the formation of the ribs in the extrusion molding step, and the continuous profile extrudate may also be embossed using the surface of the roll.

Process conditions, such as process temperature, screw speed, drawing off speed, and the like, used in the extrusion molding may vary depending on the type of polymer extruded, and the skilled artisan will understand what process conditions are suitable without undue experimentation.

In exemplary embodiments of the present invention, the step of extrusion molding can comprise co-extrusion molding to prepare a multilayer continuous profile extrudate. As will be appreciated by the skilled artisan, co-extrusion molding methods form different layers by introducing different polymer feed streams into the mold of the extruder and extruding the different polymers to form multiple layers. Each layer may be distinguished by the thickness thereof. The co-extrusion molding method can be used to form a flat structure, including at least two (or more) separate layers connected or adjacent one another at the interface thereof.

Co-extrusion molding methods use at least two (or more) feed streams of different polymers and are known in the art. The different polymers can be polymers that have different chemical properties, and/or different properties other than or in addition to different chemical properties. Exemplary multilayer structures include without limitation two layer structures including a polycarbonate layer and a polymethyl methacrylate layer; two-layer structures including a high density polyethylene (HDPE) layer and a low density polyethylene (LDPE) layer; two layer structures including an ABS layer and a PMMA layer; two layer structures including an ABS layer and a PET layer; two layer structures including a HDPE layer and a PMMA layer; two layer structures including a PC layer and an ABS layer; two layer structures including a PC layer and a PMMA layer; three layer structures including a PC layer, an ABS layer and a PMMA layer; three layer structures including a PC layer, an ABS layer, and a PC layer; and the like. The present invention is not limited to the exemplary two and three layer structures noted herein and any combination of thermoplastic resin layers including one, two three or more layers can be used.

In the co-extrusion molding method, process conditions such as process temperature, screw speed, drawing off speed, and the like also may depend on the types of polymers extruded, and the skilled artisan will understand what process conditions are suitable without undue experimentation.

In exemplary embodiments, the molded article prepared by the method of the invention can have a surface area/thickness ratio of about 300,000 to about 1,500,000 mm, for example about 500,000 to about 1,500,000 mm, and can be in the form of a sheet material (plate). When the molded article has a surface area/thickness ratio within this range, the molded article can be used for electronic device housings.

In exemplary embodiments of the present invention, in the step of extrusion molding, the continuous profile extrudate may be prepared in the form of a sheet material. When the continuous profile extrudate is prepared in the form of a sheet material, the molded article can be used for electronic device housings.

In the vacuum forming step, the continuous profile extrudate is heated and softened and then subject to pressure changes to conform the continuous profile extrudate to the shape of a vacuum forming mold.

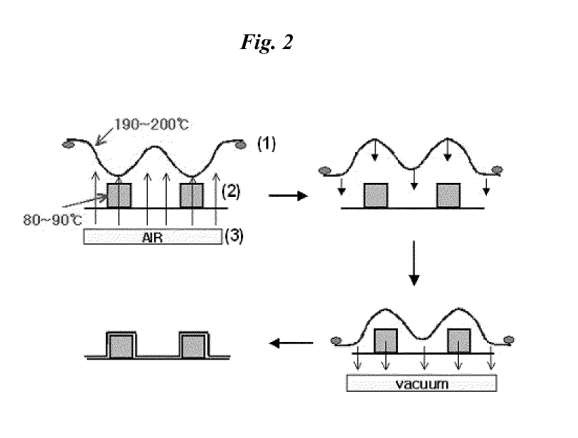

FIG. 2 is a schematic diagram of a vacuum forming line which can be used in the vacuum forming step of the invention. The vacuum forming line can include a polymer plate (1), a vacuum forming mold (2), and a heater (3), among other components.

In exemplary embodiments of the present invention, the step of vacuum forming can comprise softening the continuous profile extrudate by heating, positioning the continuous profile extrudate on a vacuum forming mold having a plurality of holes, and reducing the internal pressure of the vacuum forming mold by rapidly discharging air present in the vacuum forming mold through the holes.

For example, the step of vacuum forming can comprise softening the polymer plate (1) by heating and positioning the polymer plate on the vacuum forming mold (2) including a plurality of holes, sealing up the gap between the polymer plate and the vacuum forming mold by moving the polymer plate or the vacuum forming mold, and reducing the internal pressure of the vacuum forming mold by rapidly discharging air present in the vacuum forming mold through the holes.

In the step of vacuum forming, the form or shape of the continuous profile extrudate is transformed into the form of the vacuum forming mold by the pressure difference between the inside and outside of the vacuum forming mold.

In the step of vacuum forming, process conditions such as heating temperature, heating time, discharging pressure, and the like may depend on the types of polymers used and the shapes of the vacuum forming mold, and the skilled artisan will understand what process conditions are suitable without undue experimentation.

For example, the continuous profile extrudate can be softened by heating at 80 to 220° and the internal pressure of the vacuum forming mold can be reduced to a pressure of about 10 to about 1000 Pa.

In exemplary embodiments of the present invention, the method for preparing the molded article for an electronic device housing may further comprise a step of forming holes in the molded article by a punching process after the step of vacuum forming.

The present invention provides a molded article prepared by the method for preparing the molded article for an electronic device housing.

The invention may be better understood by reference to the following examples which are intended for the purpose of illustration and are not to be construed as in any way limiting the scope of the present invention, which is defined in the claims appended hereto.

### EXAMPLES

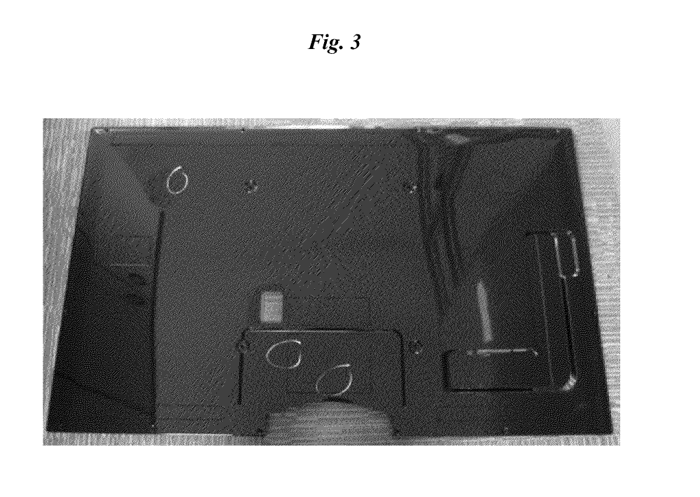

In Examples 1-9, a back cover for a 55″ TV is prepared in accordance with the composition and method set forth in Table 1. In Examples 10-11, a back cover for a 40″ TV is prepared in accordance with the composition and method set forth in Table 1. FIG. 3 is a picture of a back cover for a 55″ TV prepared according to Example 1.

In Comparative Examples 1-5, a back cover for a 55″ TV is prepared in accordance with the composition and method set forth in Table 2.

The methods used for measuring the properties of the back covers are as follows, and the measured results are shown in Table 1 and Table 2.

(1) Thickness: Five points, each of which is 10 cm away from the center of the housing, are selected, the distance between the outer surface and the inner surface is measured at the five points, and their average is calculated.

(2) Apparent specific gravity: Five points, each of which is 10 cm away from the center of the housing, are selected, samples are collected at the five points, the apparent specific gravities of the five samples are measured in accordance with ASTM D1985, and their average is calculated.

(3) Flexural modulus: The flexural modulus of the base layer is measured in accordance with ASTM D790 three times, and their average is calculated.

(4) Appearance: The number of weld lines and flow marks on the outer surface are measured by the naked eye.

(5) Gloss: The gloss is measured in accordance with ASTM D523 under the condition of 60°.

(6) Falling dart impact strength: The falling dart impact strength is determined by whether the molded article is broken by a 3 kg ball falling from a 1 m height.

TABLE 1

| | | Examples | | | | | |
|---|---|---|---|---|---|---|---|
| | | 1 | 2 | 3 | 4 | 5 | 6 |
| Housing | base | ABS | ABS | ABS | HDPE/GF | PC/ABS | PC/ABS |
| component | skin | | PMMA | PET | PMMA | | PMMA |

| Forming method | | Ex./Va. | Co-ex./Va. | Co-ex./Va. | Co-ex./Va. | Ex./Va. | Co-ex./Va. |
|---|---|---|---|---|---|---|---|
| Thickness (mm) | | 1.3 | 1.7 | 1.6 | 1.8 | 1.2 | 1.5 |
| Ratio Surface area/Thickness (mm) | | 790,000 | 600,000 | 640,000 | 570,000 | 900,000 | 720,000 |
| Apparent specific gravity (g/ml) | | 1.04 | 1.06 | 1.08 | 1.31 | 1.10 | 1.13 |
| Flexural modulus (GPa) | | 2 | 2 | 2 | 3.2 | 2.1 | 2.1 |
| Appearance (Number) | | 0 | 0 | 0 | 0 | 0 | 0 |
| Gloss (60°) | | 92 | 99 | 97 | 99 | 90 | 99 |
| Falling dart impact strength | | X | X | X | X | X | X |
| | | | Examples | | | | |
| | | | 7 | 8 | 9 | 10 | 11 |
| | Housing | base | PC/ABS | PC | PC | PC | PC |
| | component | skin | PC | | PMMA | | PMMA |

| | | | | | |
|---|---|---|---|---|---|
| Forming method | Co-ex./Va. | Ex./Va. | Co-ex./Va. | Ex./Va. | Co-ex./Va. |
| Thickness (mm) | 1.6 | 1.2 | 1.5 | 1.2 | 1.5 |
| Ratio Surface area/Thickness (mm) | 676,000 | 900,000 | 720,000 | 490,000 | 390,000 |
| Apparent specific gravity (g/ml) | 1.14 | 1.20 | 1.18 | 1.20 | 1.18 |
| Flexural modulus (GPa) | 2.1 | 2.3 | 2.3 | 2.3 | 2.3 |
| Appearance (Number) | 0 | 0 | 0 | 0 | 0 |
| Gloss (60°) | 94 | 92 | 99 | 92 | 99 |
| Falling dart impact strength | X | X | X | X | X |

Ex.: Extrusion molding, Va.: Vacuum forming, Co-ex.: Co-extrusion molding
X: Not broken
ABS: A rubber modified aromatic vinyl copolymer resin produced by Cheil Industries Inc., which is prepared by mixing a g-ABS resin, prepared by graft polymerizing 36 parts by weight styrene and 14 parts by weight acrylonitrile with 50 parts by weight polybutadiene rubber latex, and a SAN resin, prepared by copolymerizing 75 parts by weight styrene and 25 parts by weight acrylonitrile
PC: A polycarbonate resin produced by Teijin Company (product name: Panlite L-1225 grade)
PET: A polyester resin with an intrinsic viscosity of 0.76 dl/g produced by Anychem Company (product name: A1100)
PMMA: A polymethylmethacrylate resin with a weight average molecular weight of 92,000 g/mol produced by LG MMA Company (product name: L84)_
GF: A glass fiber with a length of 3 mm, a circular cross section, and a sectional diameter of 13 μm produced by Owens Corning Company (product name: 183F)

TABLE 2

| | | Comparative examples | | | | |
|---|---|---|---|---|---|---|
| | | 1 | 2 | 3 | 4 | 5 |
| Housing | base | Iron plate | Iron plate | ABS | PC/ABS | PC/ABS |
| component | skin | | | | | |

| | | | | | |
|---|---|---|---|---|---|
| Forming method | Co./Pr. | G-Co./Pr. | 1.5 mm | 1.5 mm | 3 mm |
| | | | Injec. | Injec. | Injec. |
| Thickness (mm) | 0.6 | 0.6 | 1.6 | 1.6 | 3.1 |
| Extent/Thickness (mm) | 180,000 | 180,000 | 676,000 | 676,000 | 350,000 |
| Apparent specific gravity (g/ml) | 7.83 | 7.83 | 1.04 | 1.10 | 1.10 |
| Flexural modulus (GPa) | 170 | 170 | 2 | 2.1 | 2.1 |
| Appearance (Number) | 0 | 0 | 15 | 17 | 0 |
| Gloss (60°) | 67 | 95 | 91 | 90 | 94 |
| Falling dart impact strength | X | X | X | X | X |

Co.: Coating, Pr.: Pressing, G-Co.: Gloss coating, Injec.: Injection molding
X: Not broken

As shown in Table 1, examples 1-11 exhibit good properties.

As shown in comparative examples 1-2 of Table 2, when the iron plate is used, the thickness is 0.6 mm but it is expected that total weight of the article would be increased due to an increased apparent specific gravity.

As shown in comparative examples 3-5 of Table 2, when only the injection molding method is used, the appearance of the molded article is deteriorated. In particular, as shown in comparative example 5, the molded article should be prepared with a thickness of 3 mm, in order to impart good appearance to the molded article.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A molded article for an electronic device housing having a thickness of about 0.2 to about 2 mm and an apparent specific gravity of about 0.8 to about 2.5 g/ml.

2. The molded article for an electronic device housing of claim 1, wherein the molded article has a surface area/thickness ratio of about 300,000 to about 1,500,000 mm and is in the form of a sheet.

3. The molded article for an electronic device housing of claim 1, wherein the molded article has a surface area/thickness ratio of about 500,000 to about 1,500,000 mm and is in the form of a sheet.

4. The molded article for electronic device housing of claim 1, wherein the molded article is prepared by vacuum forming a sheet material, and the sheet material is formed by extrusion molding and is a monolayer or multilayer sheet material.

5. The molded article for an electronic device housing of claim 1, wherein the molded article has a flexural modulus of about 1.8 to about 20 GPa.

6. The molded article for an electronic device housing of claim 1, wherein the molded article is prepared from a thermoplastic resin.

7. The molded article for electronic device housing of claim 6, wherein the thermoplastic resin comprises a polyolefin resin, styrenic resin, polycarbonate (PC) resin, polyester resin, polymethyl methacrylate (PMMA) resin, polyphenylene ether (PPE) resin, polyvinyl chloride (PVC) resin, or a combination thereof.

8. The molded article for an electronic device housing of claim 7, wherein the thermoplastic resin comprises acrylonitrile-butadiene-styrene copolymer (ABS), acrylonitrile-styrene copolymer (SAN), acrylonitrile-styrene-acrylate copolymer (ASA), polycarbonate (PC), polyethylene terephthalate (PET), polymethyl methacrylate (PMMA), polyphenylene ether (PPE), polyvinyl chloride (PVC), polystyrene (PS), high density polyethylene (HDPE) or a combination thereof.

9. The molded article for an electronic device housing of claim 6, wherein the thermoplastic resin further comprises one or more additives selected from the group consisting of inorganic fillers, inorganic fibers, flame retardants, heat stabilizers, mold release agents, dispersants, anti-dripping agents, weather stabilizers, antistatic agents, antibacterial agents, and combinations thereof.

10. The molded article for an electronic device housing of claim 1, wherein the electronic device is a flat panel TV.

11. A method for preparing a molded article for an electronic device housing comprising the steps of:
extrusion molding a thermoplastic resin composition to form a continuous profile extrudate with a prescribed cross-sectional shape; and
vacuum forming the continuous profile extrudate to form a molded article with a thickness of about 0.2 to about 2 mm and an apparent specific gravity of about 0.8 to about 2.5 g/ml.

12. The method of claim 11, wherein the step of extrusion molding comprises a co-extrusion molding step to form a multilayer continuous profile extrudate.

13. The method of claim 11, wherein the molded article has extent surface area/thickness ratio of about 300,000 to about 1,500,000 mm.

14. The method of claim 11, wherein the extrusion molding step comprises extrusion molding the thermoplastic resin composition to form a continuous profile extrudate in the form of a sheet material.

15. The method of claim 14, wherein the extrusion molding step includes forming ribs on the continuous profile extrudate, and wherein the method optionally further comprises embossing the continuous profile extrudate.

16. The method of claim 11, wherein the step of vacuum forming comprises softening the continuous profile extrudate by heating, positioning the continuous profile extrudate on a vacuum forming mold having a plurality of holes, and reducing the internal pressure of the vacuum forming mold by rapidly discharging air present in the vacuum forming mold through the holes.

17. The method of claim 16, wherein the vacuum forming step comprises heating the continuous profile extrudate to a temperature of about 80 to about 220° C.

18. The method of claim 16, wherein the air present in the vacuum forming mold is discharged so as to provide a pressure in the vacuum forming mold of about 10 to about 1000 Pa.

19. The method of claim 11, further comprising a step of forming holes in the molded article using a punching process after the step of vacuum forming.

20. A molded article for an electronic device housing prepared according to the method of claim 11.
